(19) United States
(12) Patent Application Publication
(10) Pub. No.: US 2009/0001712 A1
(43) Pub. Date: Jan. 1, 2009

(54) PIPE FITTING ARRANGEMENT AND METHOD FOR FORMING THE SAME

(75) Inventors: Steven Paul Webb, Tipton (GB); Alan Richard Glaze, Marlbrook (GB); Manouchehr Salehi-Bakhtiari, Cordoba (ES)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: IBP CONEX LIMITED, Tipton (GB)

(21) Appl. No.: 12/024,183

(22) Filed: Feb. 1, 2008

(30) Foreign Application Priority Data
Feb. 1, 2007 (EP) 07002183.7

(51) Int. Cl. F16L 55/00

(52) U.S. Cl. 285/55

(57) ABSTRACT

A pipe fitting arrangement in at least one embodiment comprises a pipe, a housing defining at one end an opening for insertion of an end of the pipe, a metallic grip ring and a sealing ring downstream the grip ring in the insertion direction of the pipe, the location of both the grip ring and the sealing ring between the housing and the pipe being defined by the housing, wherein the grip ring is provided with a first amount of first internal teeth directed toward the pipe in a first direction with a first inclination in the pipe insertion direction for engagement with the pipe, and with a second amount of second external teeth directed towards the housing in a second direction with a second inclination away from the pipe insertion direction for engagement with the housing. Further disclosed herein is a method for forming such a pipe fitting arrangement.

### FIELD OF THE INVENTION

The present invention refers to a pipe fitting arrangement and a method for forming said pipe fitting arrangement.

### BACKGROUND

A pipe fitting arrangement known in particular from WO 2005/114031 A2 will be discussed in further detail with respect to FIG. 1. The pipe fitting arrangement comprises a housing 100 into which a pipe, not shown, is to be inserted. The housing 100 is provided with a first shoulder 102, having a chamfer 103, a projection 104 defining a second and third shoulder, both being provided with a chamfer 105a, 105b, and a fourth shoulder 106 next to a rolled-over end 108. Between the first shoulder 102 and the projection 104, a sealing ring 110 is provided, and between the projection 104 and the rolled-over end 108, a grip ring 112 with internal teeth 114 is provided. Thus, the projection 104 fulfills a plurality of functions, namely by providing a spacer between the sealing ring 110 and the gripping ring 112, limiting the movement of the sealing ring 110 away from the pipe insertion direction, limiting a deformation of the grip ring 112 in the pipe insertion direction and supporting the pipe. The diameter of the opening 109, defined by the rolled-over end 108 and into which the pipe is to be inserted, is larger than the diameter of the projection 104 such that it will not engage the pipe, whereas the teeth 114 are configured to engage the pipe.

As soon as the pipe is inserted into the housing 100 through the opening 109, a seal between the pipe and the housing 100 is obtained by a compression of the sealing ring 110, whereas retention of the pipe within the housing 100 is provided by the engagement of the teeth 114 upon the pipe.

Although the known pipe fitting arrangement has been successfully used up to now, there are still two aspects not having been addressed in a satisfying manner by the same. On the one hand, an electric continuity between the pipe and the housing should be ensured and on the other hand, a rotation of the housing relative to the pipe should be inhibited, or at least restricted.

The first aspect, namely the electric continuity, has already been addressed in GB 2 380 532 A by providing a grip ring of a pipe fitting arrangement with a plurality of outwardly directed projections in addition to inwardly directed pipe-gripping teeth.

Thus, it is still desirable to inhibit the degree of rotation of a pipe fitted within the housing of a pipe fitting arrangement. In particular, during installation of pipe-work systems freely rotating joints can be problematic to an installer. Further, certain valves need to maintain a fixed orientation to present an operating handle to a user and thus require a rotation-free pipe fitting arrangement. Still further, orientation of pipe-work that is free to rotate will not hold a desired position and might need additional support during installation.

In addition, WO 2005/114031 A2 teaches a person to obtain the end 108 by providing the housing 100 with a front edge in form of an open tube and rolling said front edge so that this edge is deformed in order to lie at substantially 90 degrees to the remainder of the housing 100, that is to be disposed diametrically as opposed to axially of the housing 100. This needs the employment of a three wheel rolling head in order to ensure accuracy. The accuracy of the operation or better deformation is in particular critical on two counts, one being that if the grip ring is locked firmly in position with no room for flexure of the flange, this has the effect of making the grip ring rigid, even to such a degree a pipe insertion is not possible any longer. The second effect, which may occur, is the loss of electric continuity between the pipe and the housing, this also being detrimental to the operation of a pipe fitting arrangement.

Therefore, it is an aspect of the present disclosure to further develop the known pipe fitting arrangement to overcome the drawbacks of the prior art, in particular in order to ensure electric continuity between the pipe and the housing and to inhibit, or at least restrict, a relative rotation of the pipe and the housing.

### BRIEF SUMMARY

In at least one embodiment, a grip ring is provided with a first amount of first internal teeth directed toward the pipe in a first direction with a first inclination in the pipe insertion direction for engagement with the pipe, and with a second amount of second external teeth directed towards the housing in a second direction with a second inclination away from the pipe insertion direction for engagement with the housing.

Within this application, the words “tooth” or “teeth” is considered to cover all possible extensions or projections of a conventional smooth ring, independent of the specific geometry thereof, in order to provide a grip ring.

Embodiments described herein might further be characterized in that the first amount of first teeth is larger than the second amount of second teeth, in particular the second amount of second teeth requiring one or more second teeth (13, 13′).

It also proposed that the first teeth have a trapezoidal cross-section in a first plane defined by the first direction, preferably with trapezoidal recesses between neighboring first teeth.

Further, it is proposed that the free inner ends of the first teeth are arranged concentrically relative to the opposite outer ends thereof.

It can also be proposed that the cross-section of each second tooth in a second plane defined by the second direction is triangular, preferably with rounded edges.

Each second tooth can be arranged between two recesses, preferably having a triangular form, most preferably with rounded edges.

A further pipe fitting arrangement according to the invention can be characterized in that the outer free ends of the second teeth are arranged concentrically to the inner free ends of the first teeth, preferably within the outer circumference of the grip ring.

In addition, it is proposed that there is an eccentricity between the outer circumference and the inner circumference of the grip ring.

Some pipe fitting arrangements described herein are characterized by at least two opposed asymmetric features of the grip ring teeth for inhibiting clockwise and counter-clockwise rotation of the pipe relative to the housing.

It is preferred that the asymmetric features are provided by at least two additional teeth, either in form of two internal teeth, two external teeth or one internal and one external tooth.

It is further proposed that the additional teeth comprise a third amount of third internal teeth directed towards the pipe in a third direction with a third inclination towards the pipe insertion direction for engagement with the pipe, each third tooth being provided with a third edge extending above an inner circumference defined by the first internal teeth, and a fourth amount of fourth internal teeth directed towards the pipe in a fourth direction with a fourth inclination towards the pipe insertion direction for engagement with the pipe, each fourth tooth being provided with a fourth edge extending above the inner circumference defined by the first internal teeth, with the third and fourth edges having opposing angles with respect to said inner circumference.

Pipe fitting arrangements described herein can also be characterized in that the cross-section of each third tooth in a third plane defined by the third direction and/or the cross-section of each fourth tooth in a fourth plane defined by the fourth direction is trapezoidal, with preferably each third and each fourth teeth being neighbored by two first teeth with the interposition of a first recess.

In this respect, it can be proposed that the third and fourth amount are each smaller than the first amount, preferably also smaller than the second amount, with most preferably the third amount corresponding to the fourth amount.

Further, it is proposed that the first direction is opposite the second direction, and/or the first direction, the third direction and the fourth direction correspond to each other.

It is also proposed that the grip ring is bordered in the pipe insertion direction by a shoulder of the housing and away from the pipe insertion direction by a deformed end of the housing.

In addition, it is proposed that the shoulder is provided by a projection that forms a pipe support means and/or has a diameter smaller than the opening and/or limits movement of the sealing ring away from the pipe insertion direction.

In this respect, it might be beneficial that the projection is provided with a chamfer to form a limit for the movement of the first, third and/or fourth teeth of the grip ring.

It is also proposed that the second teeth of the grip ring are arranged between the shoulder and the deformed end.

Pipe fitting arrangements are provided which are characterized in that a support tube or liner inserted into the pipe, when the pipe is a plastic pipe.

Finally, also described herein is a method for forming a pipe fitting arrangement as described above, which is characterized in that, the grip ring is formed from a flat ring by bending or folding the first as well as second teeth, the first teeth being bended or folded in the first direction in order to have the first inclination towards the pipe insertion direction and the second teeth being bended or folded in the second direction in order to have the second inclination away from the pipe insertion direction.

Also, the third and fourth internal teeth can be bended or folded in the third and fourth direction, respectively, in order to have the third and fourth inclination relative to the pipe insertion direction, respectively.

It is also proposed that the first teeth, the second teeth, the third teeth and/or fourth teeth are cut or punched out, machined or cast.

Still further, it is proposed that the first teeth, the third teeth and/or the fourth teeth are trapezoidally formed, with triangular recesses therebetween prior to bending or folding said teeth.

A preferred method is characterized in that each second tooth is triangularly formed between two triangular recesses prior to bending or folding said tooth.

Further, it is proposed that the housing is formed with at least three internal shoulders and an open end, in particular by casting, forging and/or machining, in order to insert the sealing ring between the first two shoulders and the grip ring abutting against the third shoulder and thereafter deforming the free end of the housing to encapsulate the grip ring.

For this purpose, it is also proposed that the housing together with the sealing ring and the grip ring is inserted into a recess within a first surface of a die, and a punch with a first surface defining the outer contour of the deformed end of the housing is moved towards the die in order to fold or bend the free end of the housing.

This method can be further characterized in that the first surface of the die mates the first surface of the punch, the housing being arranged between said first surfaces, preferably one of said first surfaces having at least one recess for receiving therein at least one projection of the other first surface.

It is also proposed that the housing is formed with at least one feature on its outer surface, like a first outer step, to engage a mating feature within the die for support and/or the housing is formed with at least one feature on its outer surface, like a second outer step, to engage a mating feature within the punch for support.

It is further proposed that the housing is provided with a thinned region, preferably between the third shoulder and the free end, to define a bending point of the free end prior to its deformation, to the deformed end.

It is preferred that the thinned region is provided by at least one third outer step and/or outer chamfer, preferably by machining and/or that the thinned region is provided by at least one internal step and/or internal chamfer, preferably by machining.

A unique feature described herein is that a metallic grip ring with internal teeth engaging a pipe and external teeth engaging a housing, which ensure electric continuity, also inhibit a rotation of the pipe relative to the housing by bending the internal teeth opposite the external teeth, namely the internal teeth towards the pipe insertion direction and the external teeth away from the pipe insertion direction.

In order to hold the grip ring within the housing, without effecting the above described functions thereof, an encapsulation of the grip ring within the housing is proposed, without employing time consuming and complicated rolling procedures, namely by punching a free end of the housing against the external teeth of the grip ring. This ensures a high accuracy, and in particular avoids that the grip ring is locked, distorted or becomes rigid to such an extent that it cannot fulfill its grip ring functions within a pipe fitting arrangement.

### DESCRIPTION OF THE DRAWINGS

The invention will now be further described, by way of example, with reference to the accompanying drawings, in which:

FIG. 1 is a longitudinal cross-sectional view of a housing of a known pipe fitting arrangement;

FIG. 2a is a part longitudinal cross-sectional view of a housing of a pipe fitting arrangement of the invention, prior to insertion of a pipe;

FIG. 2b is a part longitudinal cross-sectional view of the housing of FIG. 2a with an inserted tube;

FIGS. 3a and 3b are views of a grip ring to be used in a pipe fitting arrangement of FIGS. 2a and 2b;

FIG. 4a is a view of an alternative grip ring to be used in a pipe fitting arrangement of the invention, without external teeth shown;

FIG. 4b is a part perspective view of the grip ring of FIG. 4a on a pipe;

FIG. 5a is a longitudinal cross-sectional view of a housing within a die prior to applying a pressing action by a punch;

FIG. 5b is a longitudinal cross-sectional view corresponding to FIG. 5a with the punch engaging the die;

FIG. 6a is a part longitudinal cross-sectional view of an alternative arrangement of a housing between a die and a punch; and

FIG. 7a to 7c are part longitudinal cross-sectional views of a housing with a thinned portion at its free end.

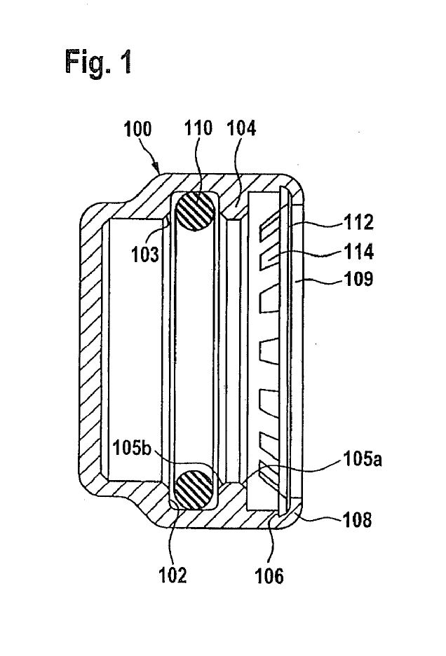

### DETAILED DESCRIPTION

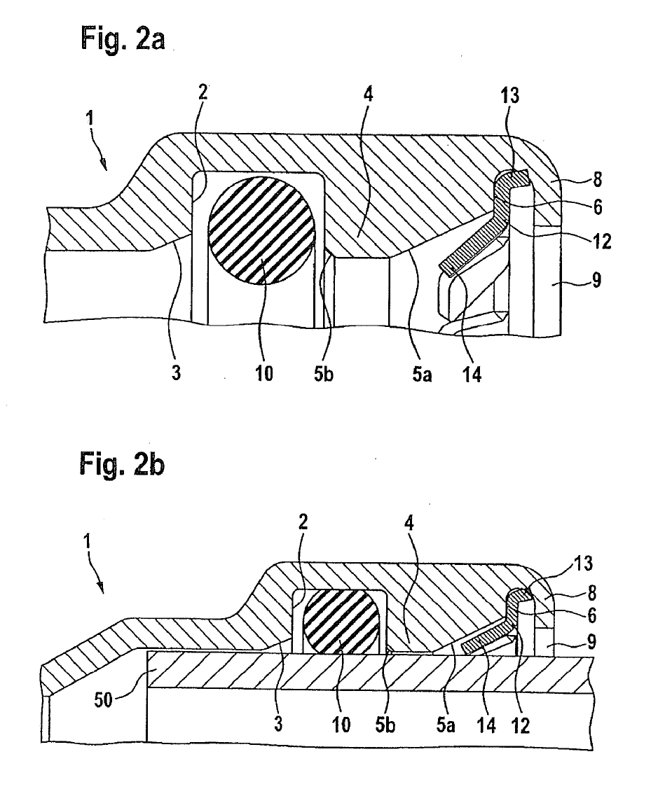

As can be seen from FIG. 2a, in at least one embodiment, a pipe fitting arrangement comprises a housing 1 having a first shoulder 2 with a chamfer 3, a projection 4 providing a second shoulder with a chamfer 5b, a third shoulder with a chamfer 5a next to a fourth shoulder 6 and a folded end 8 defining an opening 9. Between the first shoulder 2 and the second shoulder of the projection 4, a sealing ring 10 is arranged, whereas between the fourth shoulder 6 and the folded end 8, a grip ring 12 is arranged. The grip ring 12 comprises first external teeth 13 engaging the housing 1 and second internal teeth 14 engaging a pipe as soon as having been inserted into the housing 1 through the opening 9 as shown in FIG. 2b, with the movement of the grip ring 12 being limited by the third and fourth shoulder of the projection 4.

Thus, FIG. 2b depicts a pipe fitting arrangement with a pipe 50 ensuring a seal due to compressing the sealing ring 10 while abutting in particular against the projection 4, whereas retention of the pipe 50 within the housing 1 is provided by the engagement of the internal teeth 14 of the grip ring 12 on the pipe 50. Still further, a rotation of the pipe 50 relative the housing 1 is inhibited by the opposite orientation of the external and internal teeth 13, 14 of the grip ring 12. The internal teeth 14 engaging the pipe 50 and the external teeth 13 engaging the housing 1 in addition ensure electric continuity between the pipe 50 and the housing 1 as the grip ring 12 is formed from a metal.

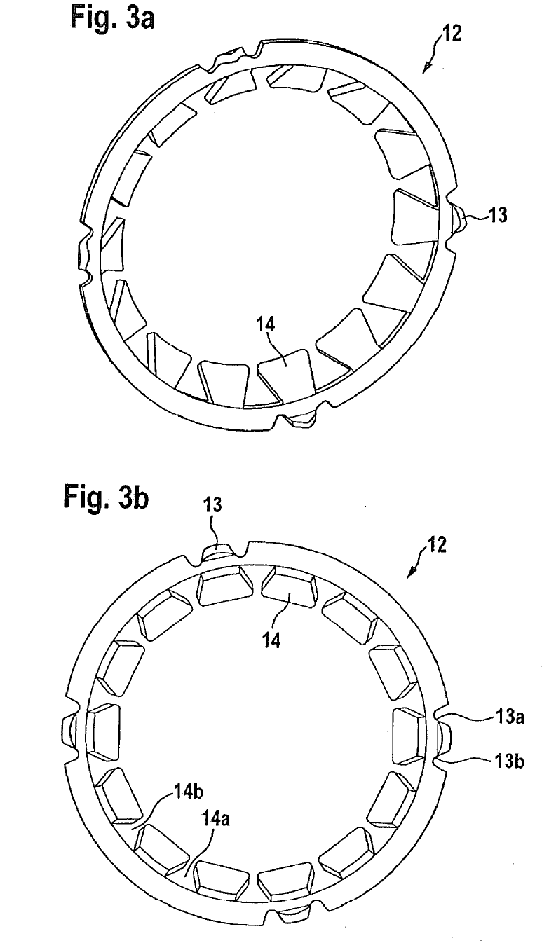

The metallic grip ring 12, shown in detail in FIGS. 3a and 3b, is formed from a flat metallic ring by cutting out triangular recesses 14a, 14b in order to leave the trapezoidal internal teeth 14 which have to be bent in a first direction in order to have a first inclination relative to the original flat ring. In addition, substantial triangular recesses 13a, 13b are cut out to leave the substantially triangular outer teeth 13 which have to be bent in a second direction to have an inclination relative to the original flat ring opposite the first inclination.

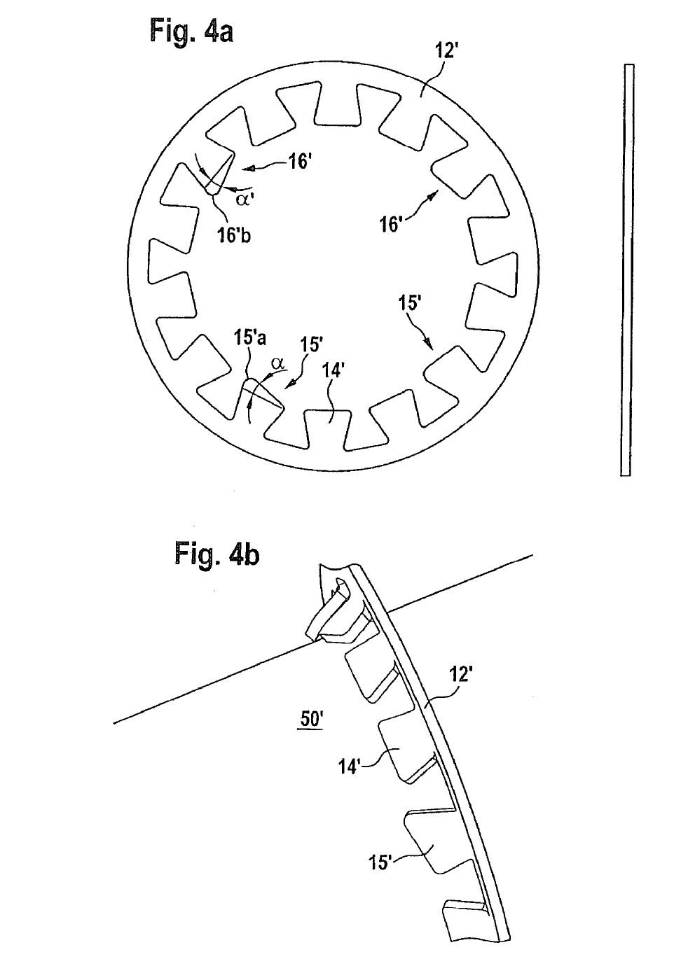

The anti-rotational locking features of the internal teeth 14 can be supplemented by providing additional, differently shaped internal teeth as shown in FIGS. 4a and 4b (having the external teeth omitted for clarity purposes). In particular, FIG. 4a shows a sealing ring 12′ after having cut out recesses but prior to applying a bending action. As can be seen, the sealing ring 12′ comprises three different internal teeth, namely first internal teeth 14′, the free ends of which lie on an inner circumference which is concentric to the outer circumference of the grip ring 12, second internal teeth 15′ having an edge 15′a extending above said inner circumference defined by the first internal teeth 14′ with an angle α, and third internal teeth 16′ with an edge 16′b extending above said inner circumference defined by the first internal teeth 14′ with an angle α′. Thus, the second and third internal teeth 15′, 16′ are provided with edges 15′a, 16′a having opposing angles in order to inhibit rotation in both clockwise and counter-clockwise direction after having been bent as shown in FIG. 4b.

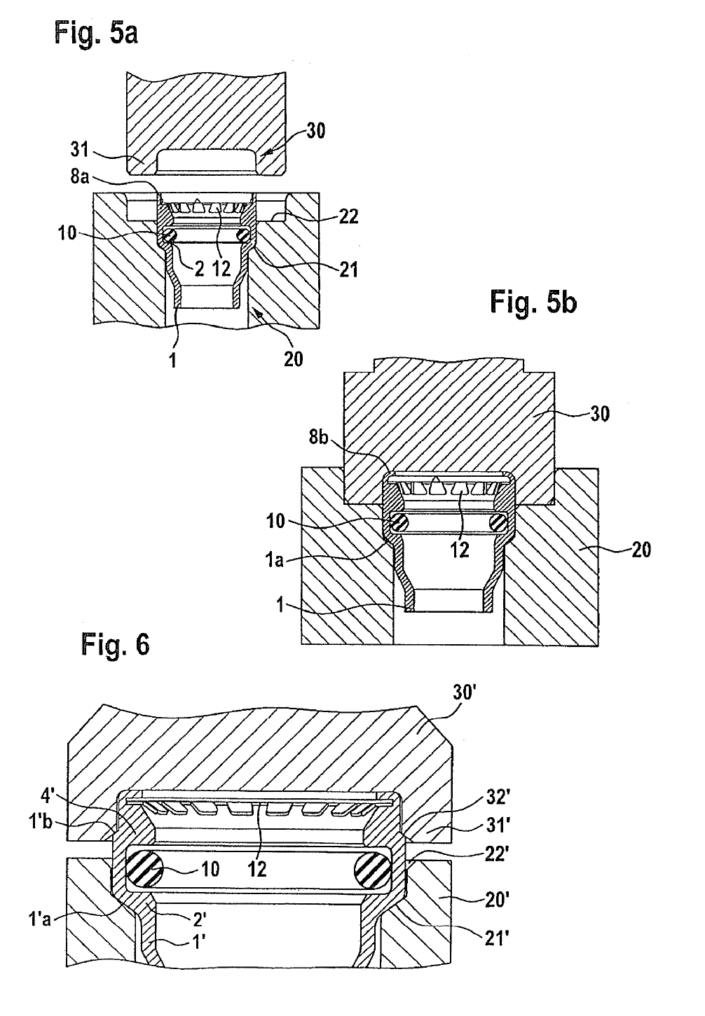

FIGS. 5a and 5b depict the forming of the folded edge 8. In particular, FIG. 5a shows a die 20 having a shoulder 21 provided with a recess 22 to receive the housing 1, said shoulder 21 mating with a step 1b provided on the outer surface of the housing 1 in the region of the first shoulder 2. The housing 1 is originally formed with an open end 8a which will be bent on the grip ring 12, in particular its outer teeth, by striking a punch 30 with a projection 31 to penetrate into the recess 22 of the die 20 against the die 20, as shown in FIG. 5b. Thus, the die 20 is shaped to provide a support on a selected feature of the outer surface of the housing 1, whereas the punch 30, being axially aligned to the die 20, has an aperture shaped to initially accommodate the free end 8a of the housing 1 and subsequently form the material thereof into the desired final shape and dimensions, i.e. the deformed end 8b. For this purpose, the opposite surfaces of the die 20 and the punch 30 mate each other.

FIG. 6 shows a housing 1′ with an alternative outer structure having in addition to a first step 1′a to abut against a first shoulder 21′ of a die 20′ within a recess 22′, a second step 1′b to abut against a chamfer 32′ of a projection 31′ of a punch 30′, with the first external step 1′a being arranged in the region of the first internal shoulder 2′ and the second external step 1′b being arranged in the region of the projection 4′ of the housing 1′.

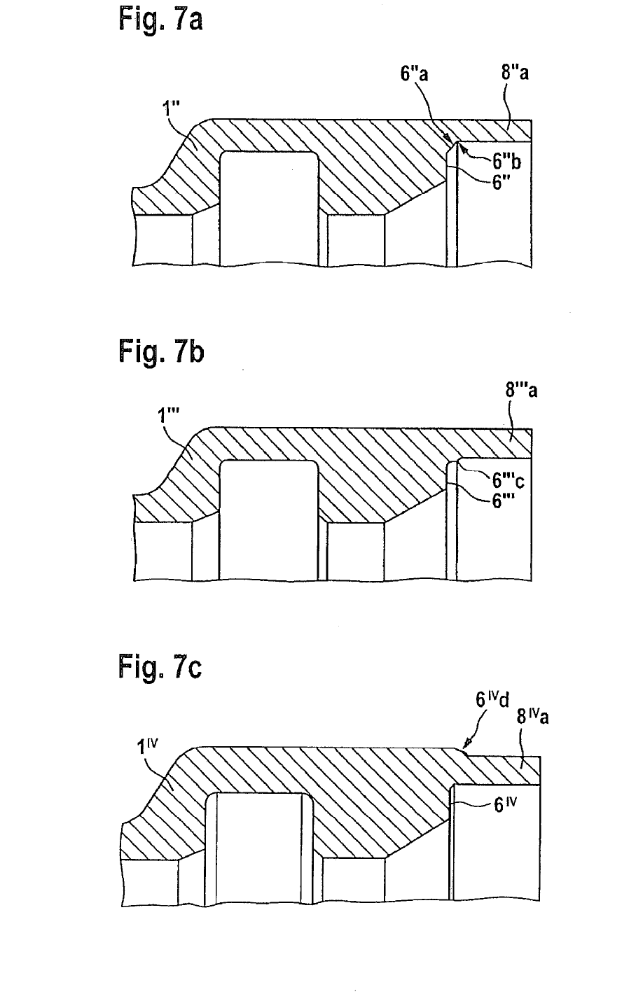

In order to facilitate the striking or punching action and to enhance the accuracy thereof, the housing can be provided with a material thinning between the fourth shoulder and the open end. As can be seen in FIG. 7a, the housing 1″ might be provided with an internal chamfer 6″a between the shoulder 6′″ and the open end 8″a in order to define a bending point 6″b. In line with FIG. 7b, an internal step 6′″c can be arranged between the shoulder 6′″ and the open end 8′″a of the housing 1′″. Thus, the alternatives of FIGS. 7a and 7b provide a material thinning from the inside of the housing, whereas FIG. 7c shows one embodiment with a material thinning from the outside of the housing 1′^{v} via an external step 6′^{v}d opposite the shoulder 6′^{v}d and the open end 8′^{v}a. In all three cases shown in FIGS. 7a to 7c, a bending point of the open end to optimize the formation of the deformed end is defined by a material thinning.

Although modifications and changes may be suggested by those skilled in the art, it is the intention of the application to embody within the patent warranted hereon all changes and modifications as reasonably and probably come within the scope of this contribution to the art. The features of the present invention which are believed to be novel are set forth in detail in the appended claims. The features disclosed in the description, the figures as well as the claims could be essential alone or in every combination for the realization of the invention in its different embodiments.

### REFERENCE SIGNS LIST

1, 1′, 1″, 1′″, 1′^{v} housing
1a, 1′a, 1′b step
2, 2′ shoulder
3 chamfer
4 projection
5a, 5b chamfer
6, 6′, 6″, 6′″, 6′^{v} shoulder
6″a chamfer
6″b bending point
6′″c step
6′^{v}d step
8 folded end
8a, 8″a, 8′″a, 8′^{v}a open end
8b deformed end
9 opening
10 sealing ring
12, 12′ grip ring
13 external tooth
13a, 13b recess
14, 14′ internal tooth
14a, 14b recess
15′ internal tooth
15′a edge
16′ internal tooth
16′b edge
20, 20′ die
21, 21′ shoulder
22, 22′ recess
30, 30′ punch
31, 31′ projection
32, 32′ chamfer
50, 50′ pipe
100 housing
102 shoulder
103 chamfer
104 projection
105a, 105b chamfer
106 shoulder
108 rolled-over end
109 opening
110 sealing ring
112 grip ring
114 internal teeth

We claim:

1. A pipe fitting arrangement comprising a pipe, a housing defining at one end an opening for insertion of an end of the pipe, a metallic grip ring and a sealing ring downstream the grip ring in the insertion direction of the pipe, the location of both the grip ring as well as the sealing ring between the housing and the pipe being defined by the housing, wherein the grip ring is provided with a first amount of first internal teeth directed toward the pipe in a first direction with a first inclination in the pipe insertion direction for engagement with the pipe and with a second amount of second external teeth directed towards the housing in a second direction with a second inclination away from the pipe insertion direction for engagement with the housing.

2. The pipe fitting arrangement according to claim 1, wherein the first amount of first teeth is larger than the second amount of second teeth, the second amount of second teeth requiring one or more second teeth.

3. The pipe fitting arrangement according to claim 1, wherein the first teeth have a trapezoidal cross-section in a first plane defined by the first direction, with trapezoidal recesses between neighboring first teeth.

4. The pipe fitting arrangement according to claim 1, wherein the free inner ends of the first teeth are arranged concentrically relative to the opposite outer ends thereof.

5. The pipe fitting arrangement according to claim 1, wherein the cross-section of each second tooth in a second plane defined by the second direction is triangular, preferably with rounded edges.

6. The pipe fitting arrangement according to claim 1, wherein each second tooth is arranged between two recesses, and each second tooth has a triangular form and/or is provided with rounded edges.

7. The pipe fitting arrangement according to claim 1, wherein the first teeth have inner free ends and the second teeth have outer free ends, and wherein the outer free ends of the second teeth are arranged concentrically to the inner free ends of the first teeth within the outer circumference of the grip ring.

8. The pipe fitting arrangement according to claim 1, further comprising an eccentricity between the outer circumference and the inner circumference of the grip ring.

9. The pipe fitting arrangement according to claim 1, further comprising at least two opposed asymmetric features of the grip ring teeth for inhibiting clockwise and counter-clockwise rotation of the pipe relative to the housing.

10. The pipe fitting arrangement according to claim 9, wherein the asymmetric features are provided by at least two additional teeth, either in the form of two internal teeth, two external teeth, or one internal and one external tooth.

11. The pipe fitting arrangement according to claim 10, wherein the additional teeth comprise a third amount of third internal teeth directed towards the pipe in a third direction with a third inclination towards the pipe insertion direction for engagement with the pipe, each third tooth being provided with a third edge extending above an inner circumference defined by the first internal teeth, and a fourth amount of fourth internal teeth directed towards the pipe in a fourth direction with a fourth inclination towards the pipe insertion direction for engagement with the pipe, each fourth tooth being provided with a fourth edge extending above the inner circumference defined by the first internal teeth, with the third and fourth edges having opposing angles with respect to said internal inner circumference.

12. The pipe fitting arrangement according to claim 11, wherein the cross-section of each third tooth in a third plane defined by the third direction is trapezoidal, each third tooth being neighbored by two first teeth with the interposition of a first recess.

13. The pipe fitting arrangement according to claim 11, wherein the third and fourth amount are each smaller than the first amount and/or the second amount.

14. The pipe fitting arrangement according to claim 1, wherein the first direction is opposite the second direction, and/or the first direction, the third direction, and the fourth direction correspond to each other.

15. The pipe fitting arrangement according to claim 1, wherein the grip ring is bordered in the pipe insertion direction by a shoulder of the housing and away from the pipe insertion direction by a deformed end of the housing.

16. The pipe fitting arrangement according to claim 15, wherein the shoulder is provided by a projection that forms a pipe support means and/or has a diameter smaller than the opening and/or limits movement of the sealing ring away from the pipe insertion direction.

17. The pipe fitting arrangement according to claim 15, wherein the projection is provided with a chamfer to form a limit for the movement of the first, third, and/or fourth teeth of the grip ring.

18. The pipe fitting arrangement according to claim 15, wherein the second teeth of the grip ring are arranged between the shoulder and the deformed end.

19. The pipe fitting arrangement according to claim 1, further comprising a support tube or liner inserted into the pipe, when the pipe is a plastic pipe.

20. A method for forming a pipe fitting arrangement as set forth in claim 1, wherein the grip ring is formed from a flat ring by bending or folding the first as well as second teeth, the first teeth being bended or folded in the first direction in order to have the first inclination towards the pipe insertion direction and the second teeth being bended or folded in the second direction in order to have the second inclination away from the pipe insertion direction.

21. The method according to claim 20, wherein the third and fourth internal teeth are bended or folded in the third and fourth direction, respectively, in order to have the third and fourth inclination relative to the pipe insertion direction, respectively.

22. The method according to claim 20, wherein the first teeth, the second teeth, the third teeth, and/or fourth teeth are cut or punched out, machined or cast.

23. The method according to claim 20, wherein the first teeth, the third teeth, and/or the fourth teeth are trapezoidally formed, with triangular recesses therebetween prior to bending or folding said teeth.

24. The method according to claim 20, wherein each second tooth is triangularly formed between two triangular recesses prior to bending or folding said tooth.

25. The method according to claim 20, wherein the housing is formed with at least three internal shoulders and an open end by casting, forging, and/or machining, in order to insert the sealing ring between the first two shoulders and the grip ring abutting against the third shoulder and thereafter deforming the free end of the housing to encapsulate the grip ring.

26. The method according to claim 25, wherein the housing together with the sealing ring and the grip ring is inserted into a recess within a first surface of a die, and a punch with a first surface defining the outer contour of the deformed end of the housing is moved towards the die in order to fold or bend the free end of the housing.

27. The method according to claim 26, wherein the first surface of the die mates the first surface of the punch, the housing being arranged between said first surfaces, one of said first surfaces having at least one recess for receiving therein at least one projection of the other first surface.

28. The method according to claim 26, wherein the housing is formed with at least one feature on its outer surface as a first outer step, to engage a mating feature within the die for support, and/or the housing is formed with at least one feature on its outer surface as a second outer step, to engage a mating feature within the punch for support.

29. The method according to claim 25, wherein the housing is provided with a thinned region between the third shoulder and the free end, to define a bending point of the free end prior to its deformation, to the deformed end.

30. The method according to claim 29, characterized wherein the thinned region is provided by at least one third outer step and/or outer chamfer.

31. The method according to claim 29, wherein the thinned region is provided by at least one internal step and/or internal chamfer.

32. The pipe fitting arrangement according to claim 12, wherein the cross-section of each fourth tooth in a fourth plane defined by the fourth direction is trapezoidal, each fourth tooth being neighbored by two first teeth with the interposition of a first recess.

33. The pipe fitting arrangement according to claim 13, wherein the third amount corresponds to the fourth amount.
